(19) United States
(12) Patent Application Publication
(10) Pub. No.: US 2003/0110054 A1
(43) Pub. Date: Jun. 12, 2003

(54) Method of and system for consolidating and managing purchases on behalf of an entity

(75) Inventor: C. William Lindquist, Harwinton, CT (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Company, Woodcliff Lake, NJ

(21) Appl. No.: 10/137,888

(22) Filed: May 3, 2002

Related U.S. Application Data
(60) Provisional application No. 60/367,619, filed on Mar. 26, 2002.
(60) Provisional application No. 60/340,998, filed on Dec. 6, 2001.

(51) Int. Cl. G06F 17/60

(52) U.S. Cl. 705/1; 705/29

(57) ABSTRACT

A method of and system for consolidating and managing purchases and transportation of such on behalf of an entity. The system is implemented with a network. The system includes a customer terminal configured to accept orders having purchase requests, and a coordinator-controlled computer connectable to the customer terminal via the network. The coordinator-controlled computer is configured to receive the orders, analyze the orders including associating one of a plurality of suppliers to each purchase request, respectfully, and generate messages for appropriate suppliers to inform the appropriate suppliers of their purchase requests. The system further includes a plurality of supplier terminals connectable to the coordinator-controlled computer. Each supplier terminal is configured to receive messages from the coordinator-controlled terminal.

### RELATED APPLICATIONS

This application claims the benefit of prior filed co-pending U.S. Provisional Patent Application No. 60/340,998, entitled SYSTEM FOR CONSOLIDATING AND MANAGING DIRECT MATERIAL PURCHASES ON BEHALF OF ONE OR MORE ORGANIZATIONS, filed on Dec. 6, 2001, and prior filed co-pending U.S. Provisional Application No. 60/367,619, entitled METHOD OF AND SYSTEM FOR CONSOLIDATING AND MANAGING PURCHASES ON BEHALF OF AN ENTITY, filed on Mar. 26, 2002. The entire contents of both are incorporated herein by reference.

### BACKGROUND OF THE INVENTION

The present invention relates to a method of and system for consolidating and managing item purchased on behalf of an entity.

Fortune 1000 size companies, while successful at establishing relationships with a limited number of key suppliers for their material or product purchases, do not spend significant time working with the rest of their supply base. Strategic supplier programs focus on the top 80% of material or product purchases, aggregated into as few as 20 sources. However, the bottom 20% usually includes hundreds of suppliers and, due to neglect, contains a disproportionate amount of inventory, transactions, and other administrative areas ripe for efficiency and improvement. It would be beneficial for a system to consolidate the purchase of material or product items from a plurality of suppliers on behalf of the customer.

### SUMMARY OF THE INVENTION

Accordingly, the invention provides a customer-to-suppliers management tool that focuses on consolidating and managing material and product purchases for the customer. In one embodiment, the tool utilizes planning information provided by the customer's material requirements planning (“MRP”) system, enterprise resource planning (“ERP”) system, or similar production and inventory management system, and distributes that information, via a network link (e.g., via the Internet), to suppliers, partners, and employees. By obtaining and distributing the planning information, the tool manages the customer's supply chain. The tool covers many functional tasks, such as ordering supplies, expediting orders, negotiating orders, paying payables, and devising transportation solutions. Although the tool may be used with any number of entities acting as the supplier, in one specific embodiment, the tool concentrates on the approximately bottom twenty percent of suppliers that supply materials or product to the customer.

In another embodiment, the invention provides a customer-to-suppliers management system for coordinating the purchase of items from a plurality of suppliers by a customer. The system is implemented with a network. The system includes a customer terminal configured to place and accept purchase request orders, and a coordinator-controlled computer connectable to the customer terminal via the network. The coordinator-controlled computer is configured to receive the orders, analyze the orders including associating one of the plurality of suppliers to each respective purchase request, and generate messages for appropriate suppliers to inform the appropriate suppliers of the customer's purchase requests. The system further includes a plurality of supplier terminals connectable to the coordinator-controlled computer. Each supplier terminal is configured to receive messages from the coordinator-controlled terminal.

In yet another embodiment, the invention provides a customer-to-suppliers management tool for coordinating the purchase and delivery of items from a plurality of suppliers to a customer. The tool is connectable to a customer terminal and a plurality of supplier terminals via a network. The tool includes means for receiving a plurality of orders from the customer terminal. The orders include a plurality of purchase requests for items. The tool further includes means for analyzing the orders and associating one of the plurality of suppliers to each purchase request, and means for generating messages for appropriate suppliers. The messages have information for the appropriate suppliers regarding their respective purchase requests. The tool further includes means for providing invoices to the customer terminal, means for receiving financial payment from the customer, means for initiating financial payment to the plurality of suppliers, and means for initiating transportation of the items from the plurality of suppliers to the customer.

In even yet another embodiment, the invention provides a method of coordinating the purchase and delivery of items from a plurality of suppliers to a customer. The method includes the acts of receiving an order, assigning one or more items of the order with appropriate suppliers, respectively, and communicating with the plurality of suppliers. The act of communicating includes informing the appropriate suppliers of each assigned item, and informing the appropriate suppliers of the shipping instructions for each assigned item. The method further includes initiating the transportation of the one or more items from the plurality of suppliers to the customer.

Other features of the invention will become apparent by consideration of the detailed description and accompanying drawings.

### BRIEF DESCRIPTION OF THE DRAWINGS

FIG. 1 is a schematic diagram representing an exemplary customer-to-suppliers management system embodying the invention.

FIG. 2 is a schematic diagram representing an exemplary customer terminal used in the management system shown in FIG. 1.

FIG. 3 is a schematic diagram representing an exemplary system-manager-controlled computer used in the management system shown in FIG. 1.

FIG. 4 is a schematic diagram representing an exemplary financial-manager-controlled computer used in the management system shown in FIG. 1.

FIG. 5 is a schematic diagram representing an exemplary transportation-manager-controlled computer used in the management system shown in FIG. 1.

FIG. 6 is a schematic diagram representing an exemplary supplier terminal used in the management system shown in FIG. 1.

FIG. 7 is a block diagram representing a method of operation for the management system shown in FIG. 1.

### DETAILED DESCRIPTION

Before any embodiments of the invention are explained, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items. The terms “connected,” “coupled,” and “mounted,” and variations thereof are used broadly and encompass direct and indirect connections, couplings, and mountings. In addition, the terms “connected” and “coupled” are not restricted to physical or mechanical connections or couplings.

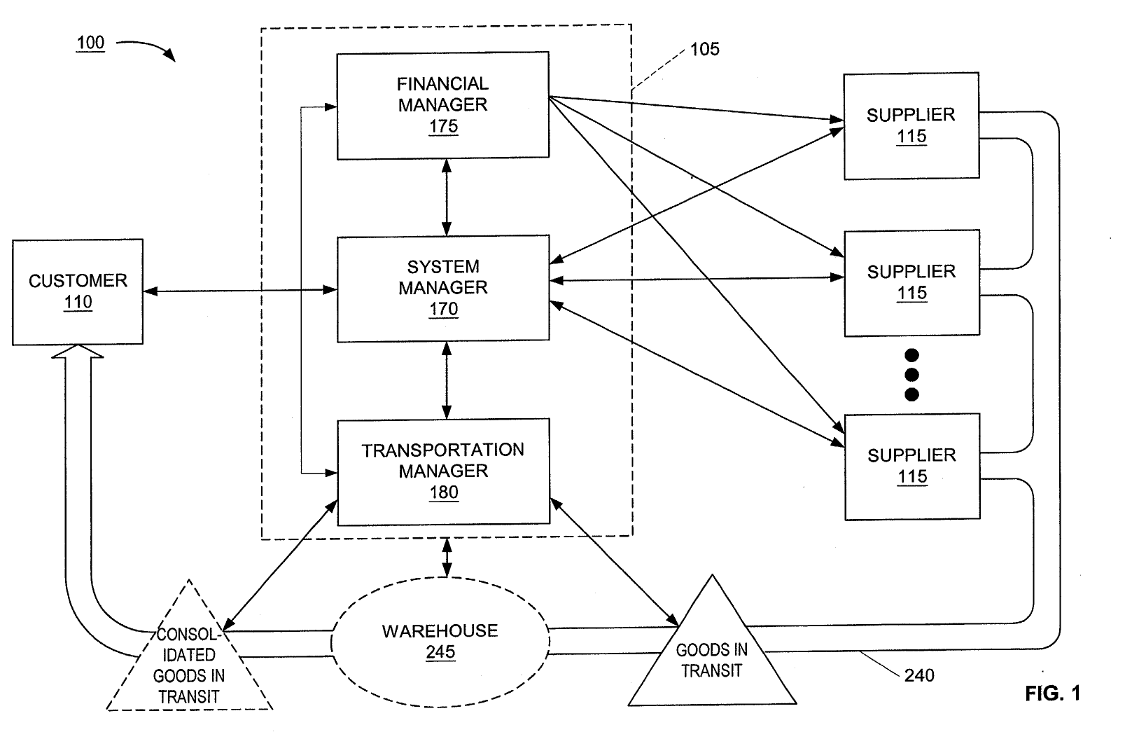

A customer-to-suppliers management system 100 is schematically shown in FIG. 1. The system 100 includes one or more managers (which form a coordinator 105) that consolidate and manage the purchase and delivery of items purchased by a customer 110 from a plurality of suppliers 115. In some embodiments, the coordinator 105 also manages the transfer of funds between the entities 105, 110 and 115. As used herein, the coordinator 105 is an entity (e.g., corporation, partnership, LLC, LLP, etc.) that purchases supplies (also referred to herein as items) from a plurality of suppliers 115. Each supplier is an entity (e.g., corporation, partnership, LLC, LLP, etc.) that makes items available for the customer 110. In some embodiments, at least one of the suppliers 115 may be a partner, division, parent, or other related organization of the customer 110 or the coordinator 105. The items are any materials, kits, sub-assembled items, products or similar supplies that are used by the customer 110 and incorporated into an end product in a manufacturing or assembly process.

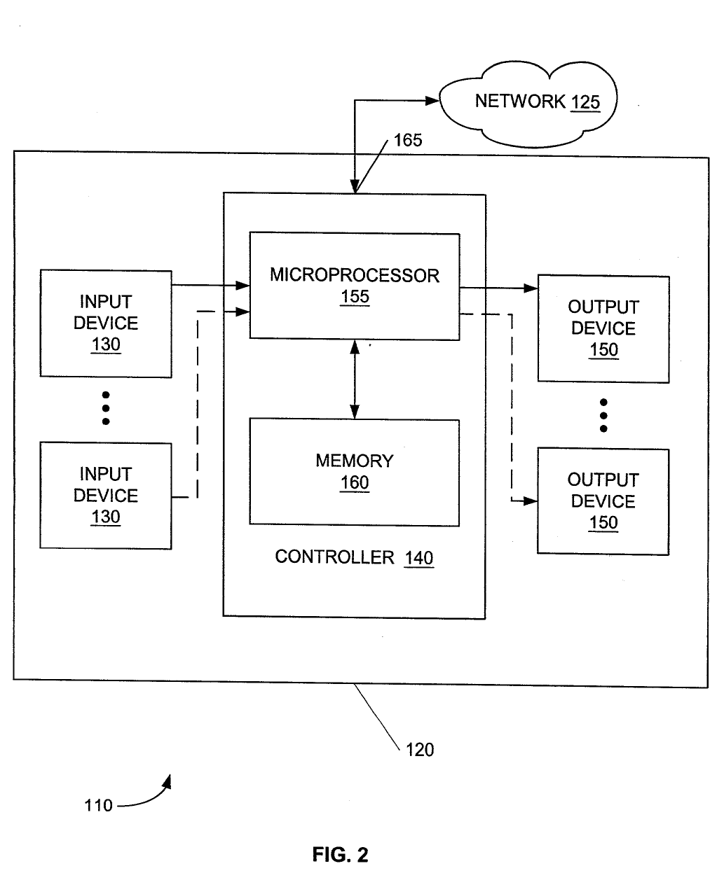

As shown in FIG. 2, the customer 110 includes a customer terminal 120 connected to a network 125 (discussed below). The customer terminal 120 is any electronic device configured to communicate with the network 125. In some embodiments, the customer terminal 120 is a stand-alone terminal that is connectable to the customer's 110 production and inventory management (PIM) system and, in other embodiments, the customer terminal 120 is integrated with the customer's 110 PIM system. In the embodiment shown, the terminal 110 includes one or more input devices 130, a controller 140, and one or more output devices 150.

The one or more input devices 130 receive input or data and provide the received input or data to the controller 140. Example input devices 130 include a keyboard or keypad, a pointing device (e.g., a mouse, a track ball, touch pad, etc.), a touch screen, a scanning device, or similar devices. Additionally, the customer terminal 120 receives input or data via a network connection (discussed further below).

As shown in FIG. 2, the controller 140 includes a microprocessor 155 and a memory 160. The memory 160 includes one or more software modules having instructions and the processor 155 obtains, interprets, and executes the instructions of the one or more software modules to control the operation of the customer terminal 120. While operation of the customer terminal 120 will become more apparent below, in general, the software modules configure the customer terminal 120 to interact with the customer's PIM system, to transmit orders to the coordinator 105, to receive status information or messages from the coordinator 105 (e.g., via a web site, electronic mails, etc.), to receive invoices from the coordinator 105, and to make payments to the coordinator 105. Of course, the controller 140 may include other circuitry (e.g., an analog-to-digital converter, a modem, a driver, etc.) necessary to operate the customer terminal 120. For other embodiments, the controller 120 may be constructed with any combination of integrated and/or discrete circuit components, and may be analog and/or digital based. For example and in one embodiment, the controller 120 is an application-specific-integrated circuit. Additionally, the controller 140 includes a network connection 165 allowing for the transfer of information between the customer terminal 120 and the network 125.

The one or more output devices 150 receive output or data from the controller and perform an action (e.g., displaying, printing, storing, transmitting, etc.) with the data. Example output devices include a visual display device (e.g., a monitor), a hard-copy device (e.g., a printer), a storage device (e.g., a magnetic storage device, an optic storage device), an audio device (e.g., a speaker), a communications device (e.g., an antenna), or similar devices. It is also envisioned that the input and output devices may be incorporated as one device (e.g., a touch screen).

Example customer terminals 120 that may be used with the invention include computers, Internet appliances, hand-held devices, or similar devices both wired and wireless. Additionally, while only one customer terminal 120 is shown, multiple customer terminals may be used with the invention. Further, while only one customer 110 is shown in FIG. 1, multiple customers may interact with the coordinator 105.

Referring again to FIG. 1, the system 100 includes one or more managers that form a coordinator 105. The coordinator 105 consolidates and manages the purchasing and delivery of supplies on behalf of the customer 110. That is, the customer 110 directly interacts only with the coordinator 105, while the coordinator 105 orders items from a plurality of suppliers 115 on behalf of the customer 110. Tasks consolidated by the coordinator 110 include ordering supplies, expediting such supplies, facilitating negotiation between the customer 110 and the one or more suppliers 115, managing payment between the customer 110 and the suppliers 115, and managing transportation of such supplies.

For the embodiment shown in FIG. 1, the one or more managers include a system manager 170, a financial manager 175, and a transportation manager 180. However, the invention is not limited to the arrangement shown in FIG. 1. In other embodiments, the functions performed by each manager may be combined into any number of managers and may be arranged differently than as shown in the figures. An example coordinator capable of providing such service is The 21st Supplier® Division of Ingersoll-Rand Company of Torrington, Conn.

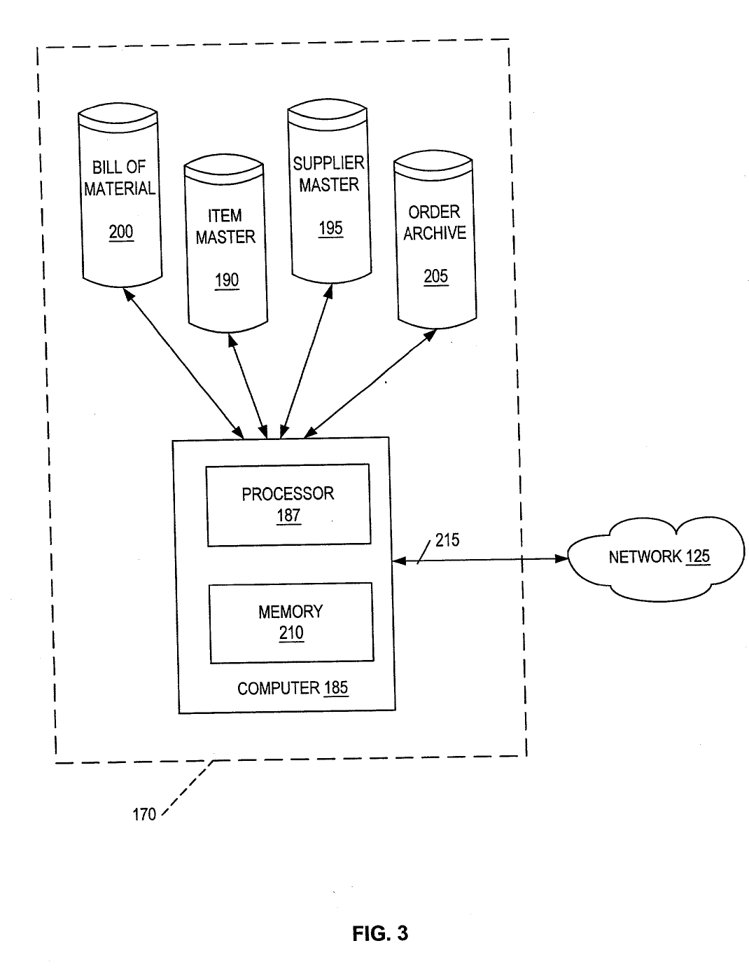

As shown in FIG. 3, the system manager 170 includes a computer 185 (which may also be referred to herein as a server), server software and a database. As used herein, the terms computer and server are not limited to a device with a single processor 187, but may encompass multiple computers linked in a system, computers with multiple processors, special purpose devices, computers or special purpose devices with various peripherals and input and output devices, software acting as a computer or server, and combinations of the above. Additionally, as used herein, the term database is not limited to a single device with memory, but may encompass multiple databases and multiple memory devices linked in a system or multiple databases incorporated on a single device. Further, while the embodiment described in the figures includes a system-manager-controlled computer 185, a financial-manager-controlled computer (discussed below), and a transportation-manager-controlled computer (discussed below), the coordinator 105 may include any number of computers, the combination of which collectively forms a coordinator-controlled computer. Referring again to FIG. 3, the system manager 170 further includes an item master database 190, a supplier master database 195, a bill of material database 200, and an order archive database 205.

The computer 185 includes a memory 210 having one or more software modules including software instructions. The processor 187 of the computer 185 obtains, interprets, and executes the instructions of the one or more software modules to control the operation of the computer 185. While the operation of the computer 185 will become more apparent below, the operation generally includes receiving, processing, and transmitting information (via network connection 240) between the customer 110, the financial manager 175, the transportation manager 180, and the plurality of suppliers 115. In some embodiments, the communication of information is facilitated in part by a communications site (e.g., a World Wide Web site) utilizing an Internet compatible protocol. The operation of the computer 185 also generally includes storing and reading information to and from the databases 190, 195, 200, and 205. An example software tool capable of being used with the computer 185 is the SupplyWorks® MAX™ brand software tool offered by SupplyWorks of Bedford, Mass.

The databases 190, 195, 200, and 205 are unique to each customer and include data necessary for the coordinator 105 to manage the ordering of supplies on behalf of the customer 110. The databases 190, 195, 200, and 205 are initially loaded with data before the coordinator 105 orders any supplies and are periodically updated or refreshed as needed.

The item master database 190 includes data for the items that the coordinator 105 is responsible for ordering. The item master database 190 includes item part numbers for the customer 110, the part number interchangeables for the appropriate supplier 115, and pricing for the item. Of course, the item master database may include other information for each item, such as an item specification, a sales history for the item, a last known inventory level for the customer, bar codes for the item, packaging instructions for the item, and similar information.

The supplier master database 195 includes data for the suppliers that the coordinator 105 manages on behalf of the customer 110. The supplier master database 195 includes locations and contact information for each supplier 115. Of course, the supplier master database 195 may include other information for each supplier 115, such as the performance level and contract information for each supplier 115.

The bill of material database 200 includes data representing the bills of material for any kit or sub-assembly item that the coordinator 105 is responsible for ordering. The bill of material database 200 includes the item numbers for the customer 110, the part numbers for items used in the kit or sub-assembly, and pricing for the items. Other information within the bill of material database 190 may include the part number interchangeables for the suppliers 115, item specifications, and assembly instructions.

The order archive database 205 includes data representing an archive of the orders, including changes or updates, managed by the coordinator 105. The order archive database 205 may include the status of any pending orders. Alternatively, the computer 185 may maintain the status of the pending orders within memory 210 until the order is completed.

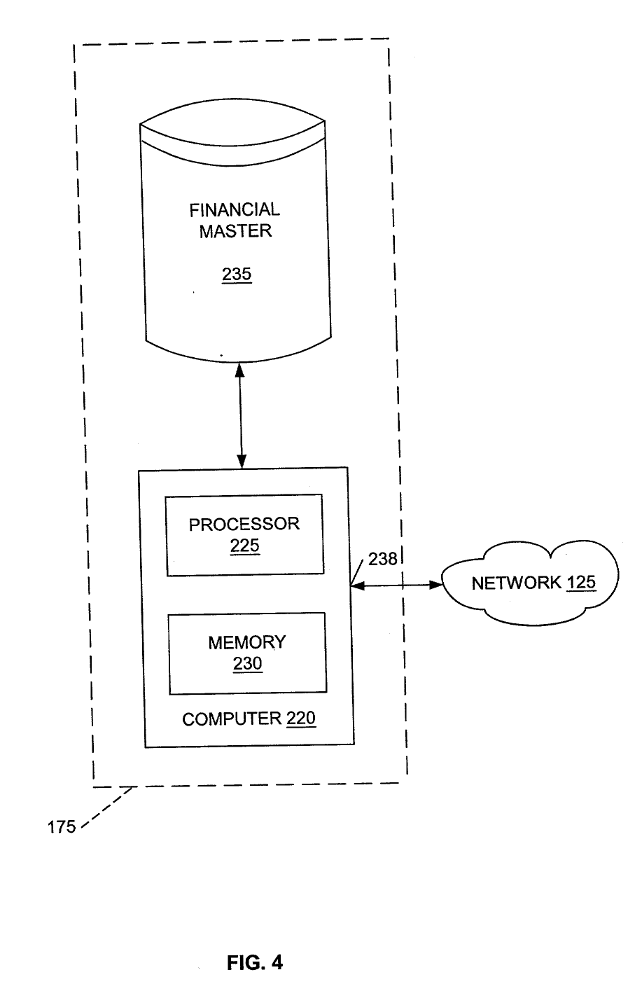

Referring again to FIG. 1, the coordinator 105 includes a financial manager 175. As shown in FIG. 4, the financial manager 175 includes a computer 220 (also referred to as the financial-manager-controlled computer 220), having a processor 225 and a memory 230, and a financial manager database 235. The memory 230 has one or more software modules including software instructions. The processor 225 obtains, interprets, and executes the instructions of the one or more software modules to control the operation of the computer 220. While the operation of the computer 220 will become more apparent below, the operation generally includes receiving, processing, and transmitting information, especially financial information, between the system manager 170, the transportation manager 180, and the plurality of suppliers 115. The transferring of financial information includes initiating, conducting, or completing financial transactions, and the communication of information is via the network connection 238. The operation of the computer 220 also generally includes storing and reading information to and from the financial manager database 235. The financial manager database 235 contains the necessary financial data for the coordinator 105 to initiate and/or conduct the transferring of financial funds between the customer 110 and the plurality of suppliers 115. Example financial data includes, but is not limited to, account numbers for the customer 110, account numbers for the suppliers 115, and contract terms. The financial manager may also coordinate payment on behalf of the customer 110 to the managers 170, 175, and 180 and third parties (e.g., a third party transportation company contracted by the transportation manager 180).

Referring again to FIG. 1, the coordinator includes a transportation manager 180. The transportation manager 180 controls the logistics of transporting the supplies from the plurality of suppliers 115 to the customer 110. The transportation of such supplies, which is represented by channel 240, may be by any means including air, sea, or land transportation, or any combination thereof. Additionally, the transportation manager 180 may consolidate such supplies for the customer 110 at a warehouse 245 or other location, and deliver consolidated goods to the customer 110. The transportation manager 180 may also include a tracking system for tracking the flow of such supplies while the supplies are within the transportation manager's 180 control.

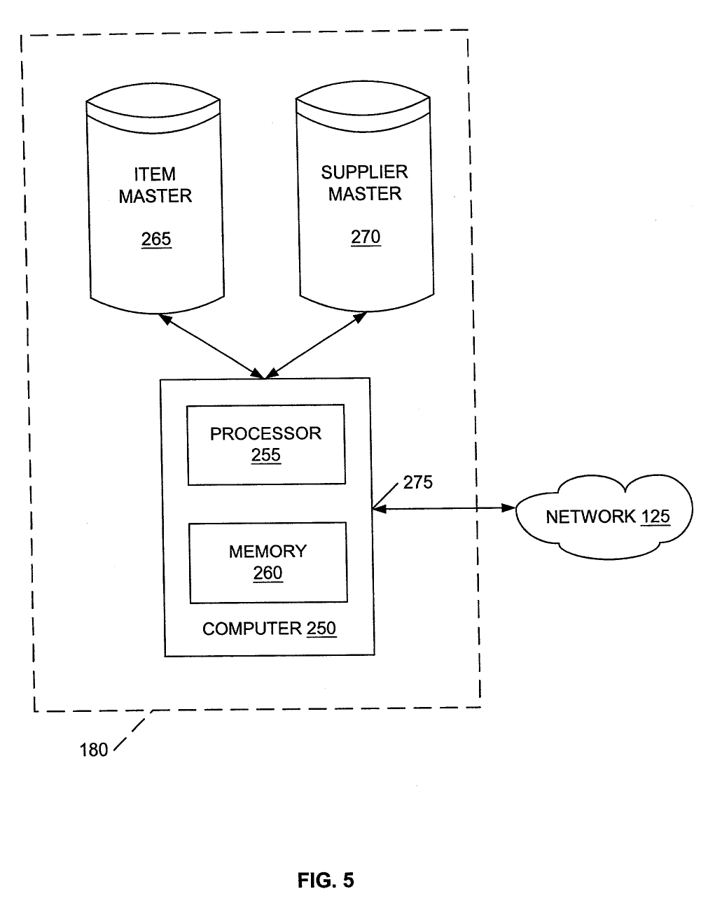

As shown in FIG. 5, the transportation manager 180 includes a computer 250 (also referred to as the transportation-manager-controlled computer 250), an item master database 265, and a supplier master database 270. The computer includes a processor 255 and a memory 260, and communicates with the network 125 via network connection 275. The memory 260 has one or more software modules including software instructions. The processor 255 obtains, interprets, and executes the instructions of the one or more software modules to control the operation of the computer 250. While the operation of the computer 250 will become more apparent below, the operation generally includes receiving, processing and transmitting information between the customer 110, the system manager 170, the financial manager 175, and the plurality of suppliers 115. The information transmitted by the transportation manager 180 includes logistics information regarding the transportation of the supplies from the plurality of suppliers 115 to the customer 110. The computer 250 is also configured to receive information regarding the flow of materials through the transportation manager system 245 (FIG. 1) and to store and read information to and from the item master database 265 and the supplier master database 270. Further and for some embodiments, the transportation manager provides advance shipping notices to the customer terminal 120.

The databases 265 and 270 are unique to each customer and include data necessary for the transportation manager 180 to manage the logistics of transporting the supplies. The databases 265 and 270 are initially loaded with data before the coordinator 105 orders supplies on behalf of the customer 110 and are periodically updated or refreshed as needed. Additionally, while the embodiment shown shows separate databases for the item master databases 190 (FIG. 3) and 265 (FIG. 5) and the supplier master databases 195 (FIG. 3) and 270 (FIG. 5), the databases 190 and 265 or the databases 195 and 270 may be combined or partitioned differently than as described herein.

Referring again to FIG. 5, the item master database 265 includes data for the items that the coordinator 105 is responsible for ordering on behalf of the customer 110. The item master database 265 includes item part numbers for the customer, a weight for each item, the packaging instructions for each item, whether the items are stackable, and other logistics related information.

The supplier master database 265 includes data relating to the suppliers 115 that are managed by the coordinator 105. The supplier master database 265 includes the hours of operation, contacts, dock information, and other logistics related information for each supplier.

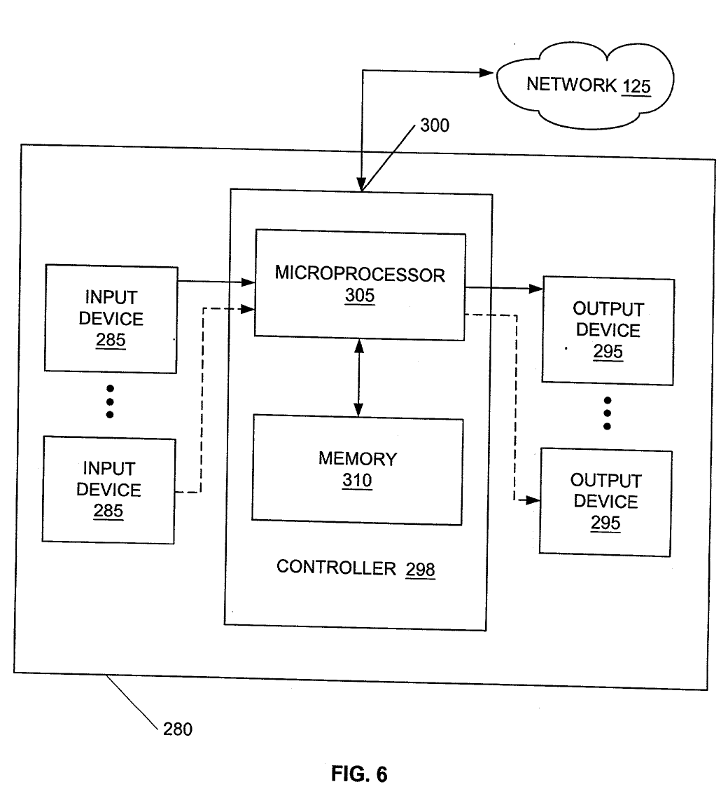

Referring again to FIG. 1, the system 100 includes a plurality of suppliers 115. Each of the suppliers 115 includes a supplier terminal adapted to communicate with the coordinator 105. The supplier terminal is any electronic device configured to communicate with the network 125. An exemplary supplier terminal 280 is shown in FIG. 6 and includes one or more input devices 285, a controller 290, and one or more output devices 295.

The one or more input devices 285 receive input or data and provide the received input or data to the controller 290. Example input devices 285 include a keyboard or keypad, a pointing device (e.g., a mouse, a track ball, touch pad, etc.), a touch screen, a scanning device, and similar input devices. Additionally, the supplier terminal 285 receives input or data via the network connection 300.

The controller 290 includes a microprocessor 305 and a memory 310. The memory 310 includes one or more software modules having instructions and the processor 305 obtains, interprets, and executes the instructions of the one or more software modules to control the operation of the supplier terminal 280. While operation of the supplier terminal 280 will become more apparent below, in general, the software modules configure the supplier terminal 280 to interact with the coordinator 105 (e.g., via a web site, electronic mail, etc.), to receive orders from the coordinator, to receive status information or messages from the coordinator 105, to receive payment or acknowledgement of payment from the coordinator 105, and to provide status information or messages to the coordinator 105. Of course, the controller 140 may include other circuitry (e.g., an analog-to-digital converter, a modem, a driver, etc.) necessary to operate the customer terminal 120. For other embodiments, the controller 120 may be constructed with any combination of integrated and/or discrete circuit components, and may be analog and/or digital based. For example and in one embodiment, the controller 140 is an application-specific-integrated circuit.

The one or more output devices 150 receive output or data from the controller 140 and perform an action (e.g., displaying, printing, storing, transmitting, etc.) with the data. Example output devices include a visual display device, a hard-copy device, a storage device, an audio device, a communications device, or similar devices. It is also envisioned that the input and output devices may be incorporated as one device (e.g., a touch screen). Example supplier terminals 280 that may be used with the invention include computers, Internet appliances, hand-held devices, and similar devices.

As shown in FIGS. 2-6, the customer 110, the plurality of suppliers 115, the systems manager 170, the financial manager 175, and the transportation manager 180, communicate via a network 125. The term network is not limited to a single network, but may encompass one or more interconnected networks. For example and in one embodiment, the network 125 is the Internet. In another embodiment, the network 125 is a dedicated network. In yet another embodiment, the network 125 is a combination of the Internet and a dedicated network. For example, the network between the customer 110, the coordinator 105, and the plurality of suppliers 115 is the Internet and the network between the system manager 170, the financial manager, and the transportation manager 180 is a dedicated network. In yet other embodiments, the network 125 includes a financial network. Other embodiments and variations will be apparent to one skilled in the art.

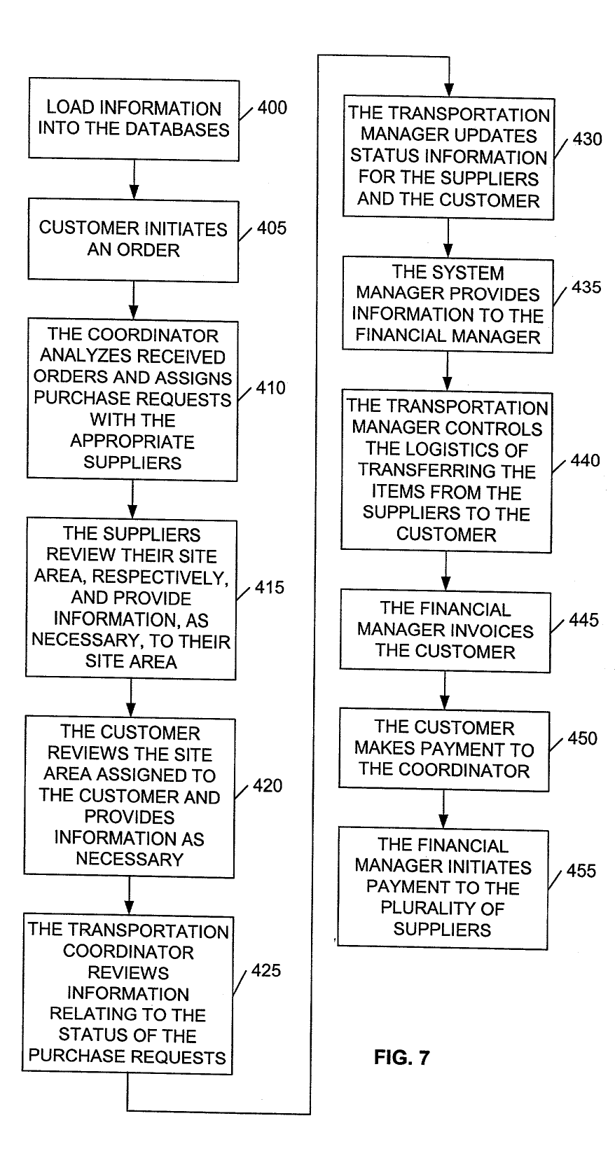

Having described a number of different arrangements for the system 100, the operation of the system will now be described with reference to FIG. 7. It should be noted that although FIG. 7 shows the acts 400-455 being in a sequence, the system 100 is running on a real-time or substantially real-time basis. That is, the system 100 performs the acts 400-455 as events are occurring and that the ordering shown is for explanatory purposes only. A number of the acts may be repeated and the sequence may vary as events occur.

At act 400, the customer 110 and/or the plurality of suppliers 115 provide information or data to the coordinator 105, and the coordinator 105 loads the information into the databases 190, 195, 200, 205, 235, 265 and 270. For example, the customer 110 and/or the plurality of suppliers 115 provide (e.g., transmit) an initial item master list, an initial supplier master list, and an initial bill of material list. At least a portion of the data on the lists are stored within the item master database 190, the supplier master database 195, and the bill of material database 200, respectively. The item master list includes the part numbers, prices, item specifications, sales histories, inventory levels, etc., of all the possible items the coordinator 105 may order on behalf of the customer 110. The supplier master list includes the locations, contact information, performance levels, contract information, etc., for all of the possible suppliers 115 that the coordinator 105 manages. The bill of material list includes the bills of material for all of the items that are ordered as a kit or subassembly.

Also, the transportation and financial managers 175 and 180 receive information necessary for each manager to perform their functions. For example, the transportation manager 180 builds the item master and the supplier master databases 265 and 270, and the financial manager 175 builds the financial manager database 235. For the item master database 265, the initial item master list (discussed above) also includes the weight, dimensions, packaging information, transportation information (e.g., if special transportation is required, is the package stackable, etc.), etc., of the items that may be logistically transferred by the transportation manager 180. For the supplier master database 270, the initial supplier master list (discussed above) also includes the pick-up locations, the hours of operation, the dock information etc., for the suppliers 115. The financial manager database 235 includes a list of the suppliers 115, contract information, account information, payment methods/terms, etc., for each supplier 115. The information for the financial manager database 235 may be obtained from the customer 110 and/or the plurality of suppliers 115. Also, the data stored within the databases 190, 195, 200, 205, 235, 265 and 270 may be updated or refreshed on a continuous and/or periodic basis.

At act 405, the customer 110 initiates an order for one or more items. Any number of ordering techniques may be used for initiating the order. For example, the customer 110 may submit a single-item purchase order, a blanket purchase order, a schedule, a demand, etc., all of which are collectively referred to herein as an “order.”The customer 110, in some embodiments, also submits item specifications, material usage reports, and/or bills of material to the coordinator 110 via the customer terminal 120.

In one embodiment, the coordinator 105 works with the customer 110 to integrate the customer terminal 120 with an existing production and inventory management (PIM) system. The PIM system may use a supply technique (e.g., a material requirement planning (“MRP”) system, an enterprise resource (“ERP”) system, an inventory min/max system, a just-in-time system, a Kanban system, etc.) that controls the purchase of materials by the customer 110. In one specific example, an MRP system generates schedules of materials necessary for an upcoming time period (e.g., generates schedules every Sunday for the upcoming week). The customer terminal 120 receives the schedule and transmits the information to the system manager 170. The system-manager-controlled computer 185 analyzes the schedules to generate purchase requests and assigns the requests to the appropriate suppliers 115. If the customer 110 uses other inventory management techniques, then the customer terminal 110 may receive other types of orders. However, in general, the system-manager-controlled computer 185 is configured to sift through the provided information and assign purchase requests to the one or more suppliers 115.

Before proceeding further, it should be noted that, in some embodiments, the customer 110 may modify and/or expedite orders. Additionally, the system manager 170 maintains all non-completed orders until the order is completed.

At act 410, the system manger 170 analyzes received orders and assigns purchase requests with the appropriate suppliers 115. That is, with each identified item, the system manager 170 determines the appropriate supplier 115 for an item and assigns the item as a purchase request to the appropriate supplier 115. In one embodiment, the system-manager-controlled computer 185 serves a communications site (e.g., a web site), where each supplier has access to an area in the communications site that is specific to them. The site area may be a single page (e.g., a single web page), a portion of a single page or multiple pages. As an item is assigned to a supplier 115, a purchase request for the item is added to the supplier's site area. The adding of information to a site area is also referred to herein as generating messages. The purchase request may include information relating to the purchase, such as the quantity of items, item specifications, a bill of material (to support kitting & sub-assembly), bar code labels, order expedites, and/or order changes. Additionally, as will become more apparent below, the information relating to the purchase request is modified as the system manager obtains more information. For example, the transportation manager 180 may provide information to the system manager 170 regarding a pack slip, a bill of lading, a manifest of goods, etc., for the suppliers 115. The provided information is added to the appropriate supplier's area. It is also envisioned that, in some embodiments, an electronic mail message is sent to a supplier 115 informing the supplier of the purchase request and/or informing the supplier that new information is added to their site area.

At act 415, the suppliers 115 review their site area, respectively, and provide information, as necessary, to their site area. For example, as a purchase order is added to supplier's area, the supplier 115 confirms that they have reviewed the order. The supplier also accepts the order if they can meet the requirements for the order. If the supplier 115 cannot accept the order or needs to modify the order, then the supplier 115 may do so via the site area. For example, if the customer 110 requests ten items within five business days and the supplier 115 can only provide six items within that time, then the supplier 115 may enter that modification via their terminal 280 and provide additional information on when the order may be completed. The information is transmitted to the customer so that the customer can plan accordingly. It is also envisioned that other suppliers 115 can bid for the purchase order if the designated supplier 115 cannot meet the original purchase order.

In some embodiments, each supplier 115 provides additional information necessary to complete the purchase request. Example information includes an inventory at the supplier, a supplier's schedules, a message that the purchase is ready for pick-up, etc.

At act 420, the customer 110 (or a customer's representative) reviews a site area assigned to the customer and provides information as necessary to the customer's site area. The customer's site area may “overlap” with each supplier's site area. The customer's site area allows the customer 110 to view the status of their orders and the status of the items in each order. For example, the customer 110 may place an order having item A and item B. Item A may be assigned to supplier A and item B may be assigned to supplier B. The customer's site allows the customer to follow the status of the order and/or the status of items A and B. If supplier A cannot satisfy the purchase request for item A, then the customer may change the purchase request as suggested by supplier A or may remove the purchase request. Similarly, if the customer 110 needs to expedite the receipt of item B, then the customer 110 may modify the purchase request for item B in the customer's site area and monitor for the supplier B's acknowledgement. Thus, the communication site facilitates negotiation between the customer 110 and the plurality of suppliers 115.

At act 425, the transportation manager reviews information relating to the status of the purchase requests. In one embodiment, the communications site includes a site area for the transportation manager 180, which may “overlap” with the site areas for the plurality of suppliers 115 and the customer 110. The transportation manager's 180 site area provides information or messages regarding the status (e.g., just assigned, item ready for pick-up, item in-transit, item delivered, etc.) of purchase requests, and an expected date of pick-up and/or deliver for each purchase request. Other information provided to the transportation manager includes quantities and changes (e.g., scheduling changes, packaging changes, etc). Based on the information provided to the transportation manager 180 at their site area and the information within the item master and supplier master databases 265 and 270, the transportation manager 180 creates the logistics for transporting the supplies to the customer 110.

At act 430, the transportation manager 180 updates status information at the areas for the respective plurality of suppliers 115 and the customer 110. In one embodiment, the transportation manager 180 accesses the transportation manager's area and provides updates regarding the transportation of items from the plurality of suppliers 115 to the customer 110. Example information includes status updates (e.g., in-transit information, pick-up dates, etc.), a manifest's of goods to be picked up per supplier, an advance shipping notice of goods for next delivery, or similar information. Upon receiving information from the transportation manager, the system manager 170 automatically updates the areas for the appropriate plurality of suppliers 115 and the customer 110. Additionally, if the transportation manager uses the warehouse 245, a report of inventory is provided to the financial manager 175 and/or the customer 110.

At act 435, the system manager 170 provides information to the financial manager 175. The information provided to the financial manager includes all open orders, all open purchase requests, supplier invoice information, and payment information from the customer 110 (discussed below). The financial manager 175 uses the information for book-keeping purposes. Also, if the transportation manager 180 uses warehouse 245, then information regarding the status of the inventory at the warehouse 245 is provided to the financial manager.

At act 440, the transportation manager controls the logistics of transferring the items from the suppliers 115 to the customer 110. The transportation of the items may be by land, sea, air, or any combination thereof. Additionally, the transportation may be performed at least in part using contracted transporters. Once the items reach the customer 110, the customer 110 and/or the transportation manager 180 provides receipt and/or delivery information to the system manager 170. The system manager 170 updates the site areas, archives the completed purchase request, and informs the financial manager 175 of the delivery.

At act 445, the financial manager invoices the customer 110. While the generation of the invoices may be at any time, in one embodiment, the invoices are generated periodically (e.g., monthly) and include single line reference information for all delivered items. That is, although the customer 110 has purchase items from any number of different suppliers 115, a single periodic invoice is generated. This reduces the complexity for the customer 110 of working with multiple suppliers 115.

At act 450, payment is made to the coordinator 105. While payment may be made by a number of different ways as is known in the art (e.g., via conventional mail, electronic transfers, etc.), in the embodiment shown, the customer 110 electronically transfers funds to an account associated with the financial manager 175.

At act 455, the financial manager 175 initiates payment to the plurality of suppliers 115. Payment to the plurality of suppliers 115 may occur on a periodic basis, when the supplier 115 invoices the coordinator 105, when the transportation manager 180 coordinates pick-up for the supplies, or by some other method known to one skilled in the art. Additionally, payment may be made by conventional mail or electronic transfers. For the embodiment shown, the financial institution 175 credits funds to an account associated with each supplier 115, respectively, on a periodic basis.

Thus, the invention provides, among other things, a new and useful method of and system for consolidating and managing purchases on behalf of an entity. Various features and advantages of the invention are set forth in the following claims.

What is claimed is:

1. A customer-to-suppliers management system for coordinating the purchase of items from a plurality of suppliers by a customer, the system being implemented with a network and comprising:
a customer terminal configured to accept orders having purchase requests;
a coordinator-controlled computer connectable to the customer terminal via the network and configured to
receive the orders,
analyze the orders including associating one of the plurality of suppliers to each respective purchase request,
generate messages for appropriate suppliers to inform the appropriate suppliers of their purchase requests; and
a plurality of supplier terminals connectable to the coordinator-controlled computer, each supplier terminal being configured to receive messages from the coordinator-controlled terminal.

2. A system as set forth in claim 1 wherein the order is in the form of a single purchase order, a blanket purchase order, a demand, a schedule, a material-usage report, or a bill of material.

3. A system as set forth in claim 1 wherein the customer has a production and inventory management system, and
wherein the customer terminal is connectable to the production and inventory management system and is configured to receive the orders from the system.

4. A system as set forth in claim 3 wherein the production and inventory management system is a material requirement planning system or an enterprise resource system.

5. A system as set forth in claim 1 wherein the has a production and inventory management system, and
wherein the production and inventory management system includes the customer terminal.

6. A system as set forth in claim 1 wherein the customer terminal is further configured to accept order changes having updated purchase requests, and
wherein the coordinator-controlled computer is further configured to
receive the order changes,
analyze the order changes including associating one of the plurality of suppliers to each updated purchase request, respectfully, and
generate messages to appropriate suppliers for informing the appropriate suppliers of their updated purchase requests.

7. A system as set forth in claim 1 wherein the coordinator-controlled computer is configured to provide a communications site.

8. A system as set forth in claim 7 wherein the communications site is an internet accessible site having a plurality of areas.

9. A system as set forth in claim 7 wherein the customer terminal is further configured to communicate with the communications site.

10. A system as set forth in claim 7 wherein the coordinator-controlled computer communicates the messages via the communications site.

11. A system as set forth in claim 7 wherein the communications site has a plurality of areas, and
wherein each supplier has an area specific to the supplier.

12. A system as set forth in claim 1 wherein the coordinator-controlled computer is further configured to generate messages for the customer, and
wherein the customer terminal is further configured to receive the messages for the customer.

13. A system as set forth in claim 12 wherein the customer messages include periodic invoice information.

14. A system as set forth in claim 1 wherein the orders include a desired date of delivery, and
wherein the messages for the suppliers include the desired date of delivery.

15. A system as set forth in claim 1 wherein each supplier terminal is further configured to acknowledge the received messages.

16. A system as set forth in claim 1 wherein each supplier terminal is further configured to create a response to a received message and to transmit the response to the coordinator-controller computer, and
wherein the coordinator-controlled computer is further configured to generate messages for the customer to inform the customer of the response.

17. A system as set forth in claim 1 wherein the coordinator-controlled computer is further configured to update the purchase requests.

18. A system as set forth in claim 1 wherein the coordinator-controlled computer is further configured to
generate additional messages for the appropriate suppliers that inform the appropriate suppliers of the shipping instructions for their purchase requests.

19. A system as set forth in claim 18 wherein the additional messages for the appropriate suppliers includes shipping information.

20. A system as set forth in claim 19 wherein the shipping information is in the form of a bill of landing, a commercial invoice, an advance shipping notice, or a packing list.

21. A system as set forth in claim 1 wherein the coordinator-controlled computer is further configured to
generate additional messages for the appropriate suppliers that inform the appropriate suppliers of the packaging instructions for their purchase requests.

22. A system as set forth in claim 21 wherein the additional messages for the suppliers include packaging instructions.

23. A system as set forth in claim 1 wherein the messages may include a bar code label for each purchase request, respectively.

24. A system as set forth in claim 1 wherein the customer terminal is further configured to accept information regarding a financial payment,
wherein the coordinator-controlled computer is further configured to receive the information regarding the financial payment, and initiate financial payments to the plurality of suppliers.

25. A system as set forth in claim 24 wherein the coordinator-controlled computer includes a system-manager-controlled computer and a financial-manager-controlled computer, the financial-manager-controlled computer being configured to initiate the financial payment to the plurality of suppliers.

26. A system as set forth in claim 1 wherein each purchase request purchases an item, and
wherein the coordinator-controlled computer is further configured to initiate the transportation of the items from the plurality of suppliers to the customer.

27. A system as set forth in claim 26 wherein the coordinator-controlled computer includes a system-manager-controlled computer and a transportation-manager-controlled computer, the transportation-manager controlled computer configured to initiate the transportation of the items from the plurality of suppliers to the customer.

28. A system as set forth in claim 27 wherein the coordinator-controlled computer is further configured to generate messages for the customer,
wherein the customer terminal is further configured to receive the messages for the customer from the coordinator controlled terminal, and
wherein the messages for the customer include status updates on the transportation of the items, respectively.

29. A customer-to-suppliers management tool for managing the purchase and delivery of items from a plurality of suppliers to a customer, the tool being connectable to a customer terminal and a plurality of supplier terminals via a network, the tool comprising:
means for receiving a plurality of orders from the customer terminal, the plurality of orders including a plurality of purchase requests for the items;
means for analyzing the orders and associating one of the plurality of suppliers to each respective purchase request;
means for generating messages for appropriate suppliers, the messages having information for the appropriate suppliers regarding their purchase requests;
means for providing invoices to the customer terminal;
means for receiving financial payment from the customer;
means for initiating financial payment to the plurality of suppliers; and
means for initiating transportation of the items from the plurality of suppliers to the customer.

30. A tool as set forth in claim 29 wherein the tool further comprises a system-manager-controlled computer, and
wherein the system-manager-controlled computer includes the means for receiving a plurality of orders, the means for analyzing the orders, and the means for generating messages.

31. A tool as set forth in claim 29 wherein the tool includes a financial-manager-controlled computer, and
wherein the financial-manager-controlled computer includes the means for initiating the financial payments.

32. A tool as set forth in claim 29 wherein the tool includes a transportation-manager-controlled computer, and
wherein the transportation-manager-controlled computer includes the means for initiating the transportation of the items.

33. A tool as set forth in claim 29 wherein the tool includes a system-manager-controlled computer, a financial-manager-controlled computer, and a transportation-manager-controlled computer,
wherein the system-manager-controlled computer includes the means for receiving a plurality of orders, the means for analyzing the orders, and the means for generating messages,
wherein the financial-manager-controlled computer includes the means for initiating the financial payments, and
wherein the transportation-manager-controlled computer includes the means for initiating the transportation of the items.

34. A tool as set forth in claim 33 wherein the system-manager-controlled computer includes the means for providing invoices, and the means for receiving financial payment, and
wherein the system-manager-controlled computer includes means for transmitting information regarding the received financial payment to the financial-manager-controlled computer.

35. A tool as set forth in claim 29 wherein the tool further comprises a processor and a memory,
wherein the means for receiving a plurality of orders, the means for analyzing the orders, the means for generating messages, the means for providing invoices, the means for receiving financial payment, the means for initiating financial payment, and the means for initiating transportation include software modules, respectively, the software modules being stored in the memory and having instructions, and
wherein the processor obtains, interprets, and executes the instructions.

36. A tool as set forth in claim 29 wherein the order is in the form of a single purchase order, a blanket purchase, a demand, a schedule, a material-usage report, or a bill of material.

37. A tool as set forth in claim 29 and further comprising:
means for receiving a plurality of order changes having updated purchase requests;
means for analyzing the order changes and associating one of the plurality of suppliers to each order change; and
wherein the means for generating messages generates messages having information for the appropriate suppliers regarding their order changes.

38. A tool as set forth in claim 29 and further comprising:
means for maintaining the status of each order.

39. A tool as set forth in claim 38 and further comprising:
means for generating messages for the customer including information regarding the status of each order.

40. A tool as set forth in claim 39 wherein the means for maintaining the status of each order includes means for maintaining the status of the purchase requests.

41. A tool as set forth in claim 29 and further comprising:
means for maintaining the status of each purchase request.

42. A tool as set forth in claim 41 and further comprising:
means for generating customer messages including information regarding the status of each purchase request.

43. A tool as set forth in claim 41 wherein the means for generating messages for the appropriate supplier generates messages having information regarding the status of each purchase request.

44. A tool as set forth in claim 29 wherein the means for providing invoices provides the invoices periodically.

45. A tool as set forth in claim 29 wherein the means for generating messages generates messages having information regarding the shipping instructions for each purchase request, respectively.

46. A tool as set forth in claim 29 wherein the means for generating messages further generates messages having information regarding the packaging instructions for each purchase request, respectively.

47. A method of coordinating the purchase and delivery of items from a plurality of suppliers to a customer, the method comprising:
receiving an order from the customer, the order having one or more items;
assigning the one or more items with appropriate suppliers, respectively;
informing the appropriate suppliers of each assigned item, and
informing the appropriate suppliers of the shipping instructions for each assigned item; and
initiating the transportation of the one or more items from the plurality of suppliers to the customer.

48. A method as set forth in claim 47 and further comprising:
providing an invoice to the customer, the invoice having an amount due;
receiving payment for the invoice; and
initiating payment to the appropriate suppliers.

49. A method as said forth in claim 47 wherein the order is in the form of a single purchase order, a blanket purchase order, a demand, a schedule, a material usage report, or a bill of material.

50. A method as set forth in claim 47 and further comprising:
receiving an order change from the customer, the order change having one or more item changes;
assigning the one or more item changes with appropriate suppliers, respectively; and
wherein the act of communicating with the plurality of suppliers further includes informing the appropriate suppliers of each item change.

51. A method as set forth in claim 47 wherein the act of receiving an order includes receiving an expedite instruction, and
wherein the act of communicating with the plurality of suppliers further includes informing the appropriate suppliers of the expedite instruction.

52. A method as set forth in claim 47 wherein the act of communicating with the plurality of suppliers includes informing the appropriate suppliers of the packaging instructions for each assigned item.

53. A method as set forth in claim 47 and further comprising:
receiving information from the plurality of suppliers.

54. A method as set forth in claim 53 wherein the information from the plurality of suppliers includes acknowledgement from the appropriate supplier that they are capable of supplying the assigned items.

55. A method as set forth in claim 53 wherein the information from the plurality of suppliers includes status information from the appropriate supplier regarding each assigned item.

56. A method as set forth in claim 47 and further comprising:
communicating with the customer, the act of communicating includes informing the customer on the status of the order.

57. A method as set forth in claim 47 and further comprising:
communicating with the customer, the act of communicating includes informing the customer on the status of the one or more items.

58. A method as set forth in claim 57 wherein the act of communicating with the customer further includes transmitting an advance shipment notice to the customer.

59. A method as set forth in claim 57 wherein the act of communicating with the customer further comprises providing status information of the one or more items in transit.

60. A customer-to-suppliers management system for coordinating the purchase and delivery of items from a plurality of suppliers to a customer, the system being implemented with a network and comprising:
a customer terminal configured to accept orders having purchase requests;
a coordinator-controlled computer connectable to the customer terminal via the network and configured to
receive the orders,
analyze the orders including associating one of the plurality of suppliers to each purchase request, respectfully,
generate a communications site having a plurality of areas, each area being associated with one of the suppliers, respectively, and
inform the appropriate suppliers of their respective purchase requests, including placing information in the appropriate supplier's area; and
a plurality of supplier terminals connectable to the coordinator-controlled computer, each supplier terminal configured to
access the communications site,
access the area associated with the respective supplier,
receive the information for the supplier, and
update the supplier's area, including acknowledging the purchase request.

61. A system as set forth in claim 60 wherein the coordinator-controlled computer is further configured to
generate the communications site having an area for the customer, and
inform the customer regarding the status of the purchase requests,
wherein the customer terminal is further configured to
access the communications site,
access the area associated with the customer, and
receive information for the customer.
